(19) United States
(12) Patent Application Publication
(10) Pub. No.: US 2014/0150821 A1
(43) Pub. Date: Jun. 5, 2014

(54) Valve Box Stack Cleaner

(71) Applicant: John Armour, New Port Richey, FL (US)

(72) Inventor: John Armour, New Port Richey, FL (US)

(21) Appl. No.: 13/692,001

(22) Filed: Dec. 3, 2012

(51) Int. Cl. B08B 9/027

(52) U.S. Cl. CPC B08B 9/027
USPC 134/8

(57) ABSTRACT

A method for cleaning a stack may include the steps of opening a cover of the stack, placing a cleaning tool within the stack to engage the debris within the stack, removing the debris above a valve with the cleaning tool and removing the cleaning tool from the stack. The cleaning tool may include a first cleaning blade, and the cleaning tool may include a second cleaning blade. The first cleaning blade may be a spiral discontinuous blade and a second cleaning blade may be a spiral discontinuous blade. The first cleaning blade may include a first radial cutting edge, and the first cleaning blade may include a first radial cutting edge. The first cutting blade may include a first axial cutting edge, and the second cutting blade may include a second axial cutting edge.

### RELATED APPLICATIONS

The present application is a divisional application of parent application Ser. No. 12/845,144 which was filed on Jul. 28, 2010.

### PRIORITY

The present invention claims priority under 35 USC section 119 and based upon a provisional application filed on Jul. 31, 2009 with a Ser. No. 61/273,116

### FIELD OF THE INVENTION

The present invention relates to cleaning devices and more particularly to a cleaning device for cleaning a valve stack.

### BACKGROUND

At the present time, many commercial valve stacks, of the kind commonly used by utilities companies, site contractors, golf courses. The valve stacks are located below the street-level and/or ground-level have not been equipped with devices which efficiently remove contaminants, Rainwater and other types of liquids which may carry waste such as dirt, stones, grass, leaves, insects, plants, rocks, hypodermic needles and other man-made debris, and man-made products from the surface to the interior of the commercial stack where a valve may be located. The valve may be used to control the flow of a fluid such as water, gas, sewer or other types of fluids. This valve stack tends to attract these contaminants as a result of being a form of obstruction within the commercial stack. After some time, a large amount of debris may accumulate around the valve and nut, and at some time, it may become necessary for a user to service or operate the valve. The debris may inhibit this activity or may prevent the user from reaching or operating the valve. The commercial valve stack which may be a cover/lid may be difficult to access because of the limited diameter of the commercial valve stack. The valve nut may be out of arms reach which may cause additional problems. Cleaning the commercial stack may require significant amounts of manpower and time. This of course represents a financial hardship on the government agency that may be charged with maintaining or repairing the commercial valve stack.

### SUMMARY

A method for cleaning a stack may include the steps of opening a cover of the stack, placing a cleaning tool within the stack to engage the debris within the stack, removing the debris above a valve with the cleaning tool and removing the cleaning tool from the stack.

The cleaning tool may include a first cleaning blade, and the cleaning tool may include a second cleaning blade.

The first cleaning blade may be a spiral discontinuous blade and a second cleaning blade may be a spiral discontinuous blade.

The first cleaning blade may include a first radial cutting edge, and the second cleaning blade may include a second radial cutting edge.

The first cutting blade may include a first axial cutting edge, and the second cutting blade may include a second axial cutting edge.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the cutting tool of the present invention;

FIG. 2 illustrates a first step of the method of the present invention;

FIG. 3 illustrates a second step of the method of the present invention;

FIG. 4 illustrates a third step of the method of the present invention;

FIG. 5 illustrates a fourth step of the method of the present invention;

FIG. 6 illustrates a fifth step of the method of the present invention

FIG. 7 illustrates a bottom view of the cleaning tool of the present invention;

FIG. 8 illustrates a central shaft having detachably connected sections.

### DETAILED DESCRIPTION

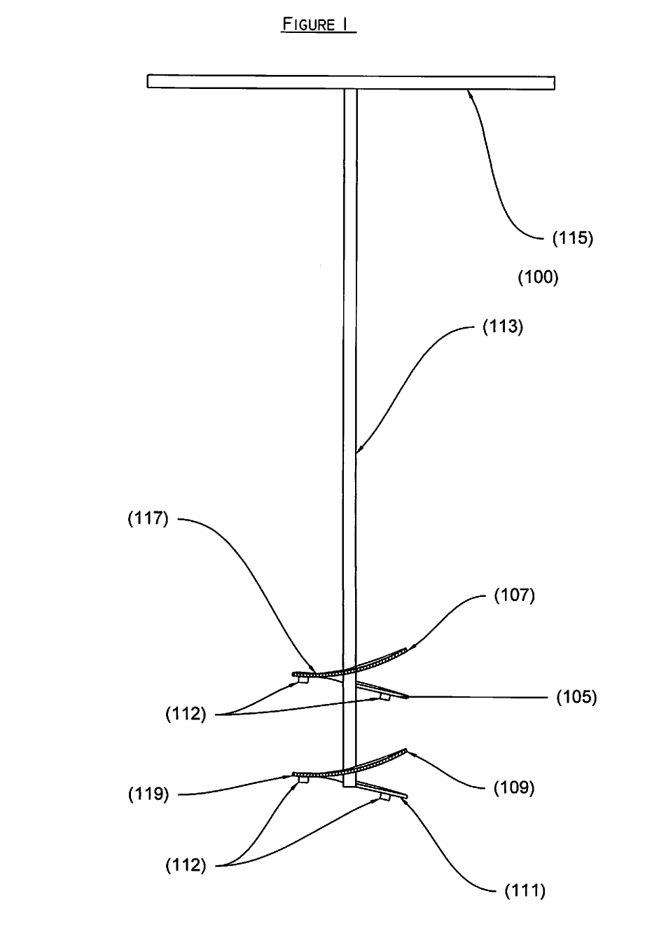

FIG. 1 illustrates a perspective view of the cleaning tool 100 of the present invention and illustrates an elongated central shaft 113 to rotate a first cleaning blade 119 and a second cleaning blade 117 to clean debris from a stack or manhole or other appropriate device which may require cleaning. The first cleaning blade 119 may be a discontinuous spiral blade which may not overlap or may be a continuous spiral blade and the second cleaning blade 117 may be a discontinuous spiral blade or may be a continuous spiral blade. The first cleaning blade 119 may be positioned at a spaced relationship with respect to the second cleaning blade 117. The first cleaning blade 119 may include a first axial cutting edge 111 which may be formed on the leading edge of the first cleaning blade 119 and may extend the approximate entire diameter of the first cleaning blade and may include a first radial cutting edge 107 which may be formed on the top outer surface of the first cleaning blade 119. Either the first cleaning blade 119 or the second cleaning blade 117 or both may include a magnet 112 to attract metal debris including broken valve portions and to allow the metal debris to be retrieved. Alternatively, the first cleaning blade 119 or the second cleaning blade 117 or both may be magnetized to achieve the above effect.

The second cleaning blade 117 may include a second axial cutting edge 111 which may be formed on the leading edge of the second cleaning blade 117 and may include a second radial cutting edge 109 which may be formed on the top outer surface of the second radial cutting edge 109.

The first cleaning blade 119 and a second cleaning blade 117 may be connected to the central shaft 113 which may be connected to the handle 115 which may be substantially traverse to the central shaft 113.

In operation, the user rotates the handle 115 which may rotate the central shaft 113 which rotates the first cutting blade 119 and the second cutting blade 117. The first and second cutting blade 111, 113 cut the debris by the rotation of the first and second radial cutting edge 109, 107 and the first axial cutting edge and the second axial cutting edge 105, 111. Although, two blades are illustrated, the present invention may include three or more blades.

A nut may be placed on the top of the tool 115 so that the operation may be performed by a drill socket or hand ratchet.

The cleaning device 100 maybe formed from metal, plastic or other suitable material.

FIG. 2 illustrates a valve stack 203 which may include a lid-cover 201 which may be removably connected to the valve stack 203, and the valve stack 203 may include debris 205 which may be formed around the valve 207. Access to the valve 207 may be obstructed by the debris 205.

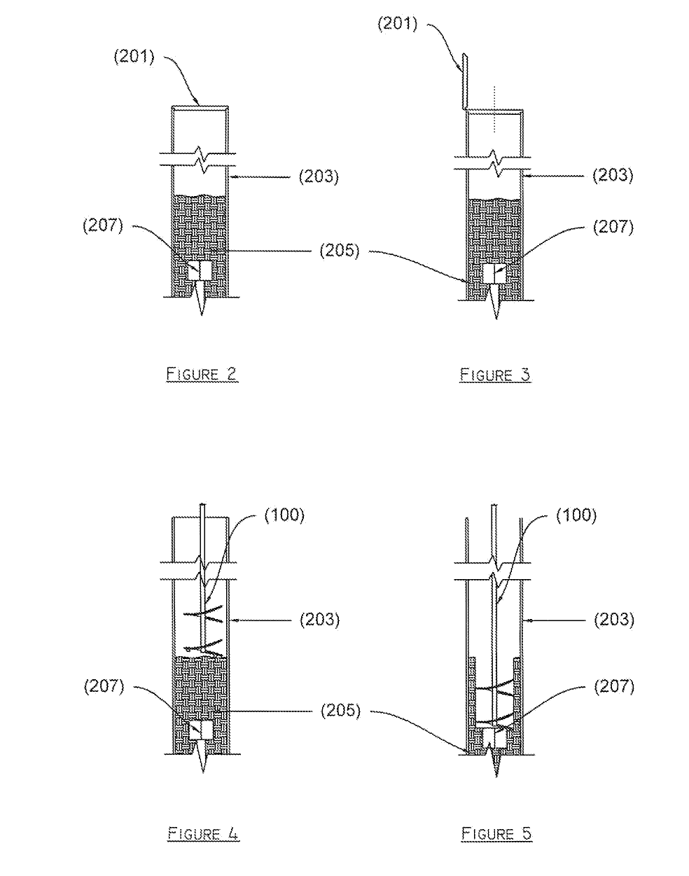

FIG. 3 illustrates that the cover 201 has been opened in order to insert the cleaning tools 100.

FIG. 4 illustrates that the cleaning tool 100 enters the valve stack 203 and may be placed adjacent to or above the debris 205.

FIG. 5 illustrates that the user rotates the cleaning tools 100 in order to remove the debris 205 from at least the top surface of the valve nut 207 which controls the operation of the valve and may be located within the housing of the valve stack 203. The nut 207 may vary in size.

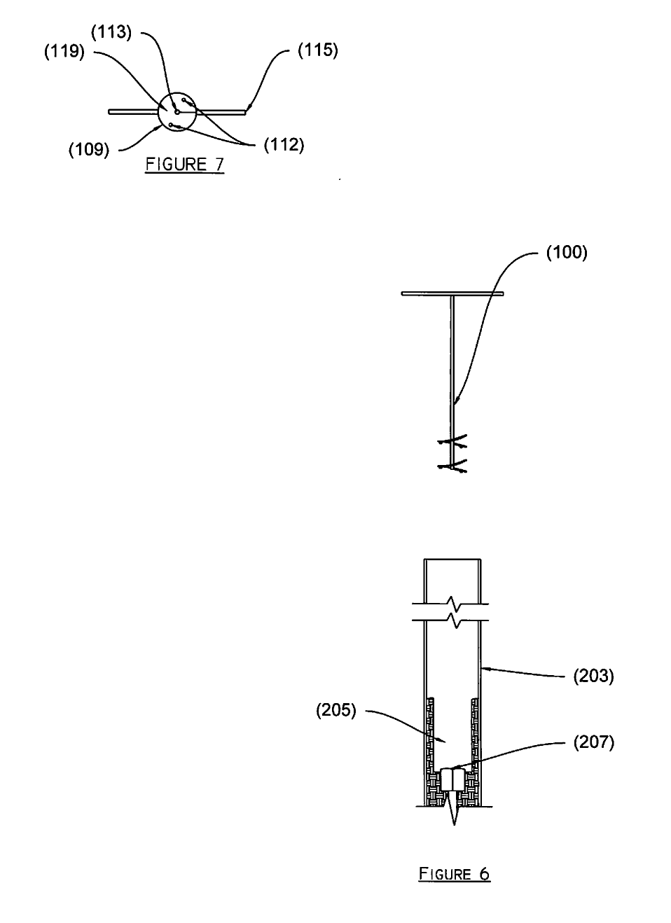

FIG. 6 illustrates that the user has removed the cleaning tool 100 from the valve stack 205 and the user may access the valve nut 207 in order to perform necessary repairs and/or maintenance.

FIG. 7 illustrates a bottom view of the cleaning tool 100 of the present invention.

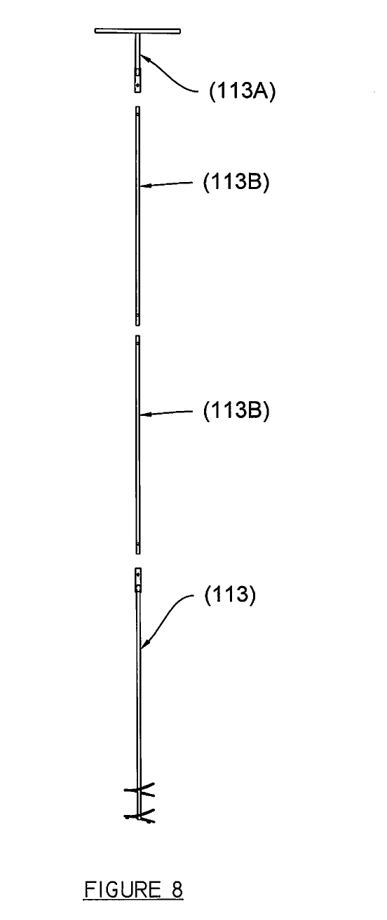

FIG. 8 illustrates that the central shaft 113 may include detachably connected sections 113a, 113b in order to vary the length of the central shaft 113 in order to accommodate valve stack 205 of different depths.

Varying the length of the central shaft 113 is advantageous to accommodate the vertical stack 205 of different depths. The couplings to connect the detachably connected sections 113a, 113b may be a securing stainless pin or other device.

The present invention can be used for gas valves or gas workers, water valves for city workers, stacks under construction for construction workers such as workers building docks.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for cleaning a stack, comprising the steps of:
opening a cover of the stack;
placing a cleaning tool within the stack to engage debris within the stack;
removing the debris above a valve in the stack with the cleaning tool;
removing the cleaning tool from the stack:
wherein the cleaning tool includes a first cleaning blade;
wherein the first cleaning blade includes a first radial cutting edge;
wherein the first cleaning blade includes a magnet to attract metal debris from the stack.

2) (canceled)

3) A method for cleaning a stack as in claim 1, wherein the cleaning tool includes a second cleaning blade.

4) (canceled)

5) A method for cleaning a stack as in claim 3, wherein the second cleaning blade includes a second radial cutting edge.

6) A method for cleaning a stack as in claim 3, wherein the second cleaning blade is a spiral continuous blade.

7) A method for cleaning a stack as in claim 1, wherein the first cleaning blade includes a continuous blade.
